(19) United States
(12) Patent Application Publication
(10) Pub. No.: US 2025/0346323 A1
(43) Pub. Date: Nov. 13, 2025

(54) Bicycle Hydraulic Brake Control Device and Bicycle

(71) Applicant: ZHUHAI L-TWOO SPORT TECHNOLOGY CO., LTD., Zhuhai, Guangdong (CN)

(72) Inventors: Chunsheng Liu, Zhuhai, Guangdong (CN); Huifeng Zhou, Zhuhai, Guangdong (CN)

(21) Appl. No.: 18/861,240

(22) PCT Filed: Aug. 11, 2022
(86) PCT No.: PCT/CN2022/111594

§ 371 Date: Aug. 4, 2025

(30) Foreign Application Priority Data
Jun. 24, 2022 (CN) 202210731314.3

(51) Int. Cl. B62L 3/02

(52) U.S. Cl. CPC B62L 3/023

(57) ABSTRACT

Disclosed are a bicycle hydraulic brake control device and a bicycle. The bicycle hydraulic brake control device includes: a control main body connected to a handlebar of a bicycle; a brake lever pivotally connected to an end of the control main body; a hydraulic cylinder connected to the control main body; a piston rod connected to the hydraulic cylinder; and a trigger member hinged to the control main body, wherein the trigger member includes a pressing portion and a pushing portion. In the brake control device, the piston rod is pushed by means of the rolling member to do a piston motion, so that hard friction between the trigger member and the piston rod is prevented to reduce the friction force between the trigger member and the piston rod and achieve a smooth hand feeling of braking, the braking effect is improved, and a rider's braking experience is also improved.

This application is based on the Chinese patent application with the application number of 202210731314.3 and the application date of Jun. 24, 2022, and claims its priority, and the entire contents of which are incorporated herein as a whole.

### TECHNICAL FIELD

The present invention belongs to the technical field of bicycles, in particular relates to a bicycle hydraulic brake control device and a bicycle.

### BACKGROUND ART

Hydraulic braking is a way to control a bicycle brake, which is based on a main principle that an operable component such as a brake lever is used to drive a piston rod to do a piston motion in a hydraulic cylinder, so that a liquid with a certain pressure, such as hydraulic oil, is output from the interior of the hydraulic cylinder to press against a brake member arranged on a wheel, thereby achieving braking and controlling a bicycle. In an existing hydraulic brake control bicycle, a hydraulic braking mechanism thereof is often fixedly arranged in a control main body connected to a handlebar of the bicycle.

The Chinese patent with the publication number CN105584575B discloses a hydraulic brake control device for a handlebar of a bicycle, and motion connection elements are further disclosed in an embodiment. The hydraulic brake control device includes single hammer 40 acting between a piston 27 and a brake lever 15a, and the hammer 40 is hinged to a shell 20 by means of a pin 22; the hammer 40 is roughly U-shaped and includes a hole 40a in which the pin 22 is inserted and a pushing and pressing end 40b which acts on the piston 27, the hole 40a of the hammer 40, a hole 24a of a cylinder 24 and a hole 20c of the shell 20 are coaxially mounted so as to allow the single pin 22 to be positioned; and during use, the brake lever 15a is pressed to extrude the hammer 40 to rotate, the pushing and pressing end 40b of the hammer 40 abuts against the piston 27 and drives the piston 27 to do a piston motion. During braking, frictional sliding is caused between an end portion of the pushing and pressing end 40b and an end portion of the piston 27, a friction surface is prone to abrasion, and the hammer 40 or the piston is damaged; and at the same time, it is easy to produce additional resistance during operation, which results in relatively hard hand feeling when a user extrudes the brake lever and requires a greater force to control the rotation of the brake lever, so that the user's braking experience is lowered. In the above-mentioned Chinese patent, a stationary shaft and a brake shaft of the hydraulic cylinder are of a coaxial structure which is relatively cumbersome to disassemble or assemble, difficult to repair, poor in reliability and not easy to maintain. The Chinese patent with the publication number CN105923098B discloses a hydraulic brake mechanism in which an oil filling port and an exhaust port in a hydraulic cylinder are combined, by which interaction between an oil filling process of an oil storage chamber and an exhaust process of a piston chamber is easy to occur.

### SUMMARY OF THE INVENTION

An object of the present invention is to provide a bicycle hydraulic brake control device reasonable and compact in structural design, unprone to abrasion between a trigger member and a piston rod, smooth in hand feeling of braking, good in braking effect, high in reliability, easy to disassemble, overhaul and maintain and free of interaction between oil filling of an oil storage chamber and exhaust of a piston chamber and a bicycle so as to solve the above-mentioned problems in an existing hydraulic brake control device.

In order to solve the above-mentioned technical problems, the present invention is achieved by means of the following technical solutions:
a bicycle hydraulic brake control device includes:
   a control main body, the control main body being connected to a handlebar of a bicycle;
   a brake lever, the brake lever being pivotally connected to an end, away from the handlebar, of the control main body by means of a first pivot;
   a hydraulic cylinder, the hydraulic cylinder being connected to the interior of the control main body;
   a piston rod, one end of the piston rod being movably arranged in the hydraulic cylinder, and the other end thereof extending out of one end of the hydraulic cylinder; and
   a trigger member, the trigger member being hinged to the interior of the control main body and being located on one side of the hydraulic cylinder, and the trigger member being used for pushing the piston rod to move along the interior of the hydraulic cylinder and extruding hydraulic oil located in the hydraulic cylinder;
wherein the trigger member includes a pressing portion and a pushing portion which are connected to each other at a preset angle, an end, away from the pushing portion, of the pressing portion abuts against an inner wall of the brake lever, and an end, away from the pressing portion, of the pushing portion is connected to an end, extending out of the hydraulic cylinder, of the piston rod by means of a rolling member; and the rolling member can roll along an end portion of the piston rod when the brake lever rotates along the first pivot and extrudes the trigger member.

Preferably, the rolling member is a rolling bearing pivotally connected to the end, away from the pressing portion, of the pushing portion.

Preferably, the end portion, away from the pressing portion, of the pushing portion is provided with a U-shaped groove for containing the rolling bearing, and the rolling bearing is pivotally connected to the interior of the U-shaped groove by means of a second pivot.

Preferably, the rolling bearing is a ball bearing, a roller bearing, a needle roller bearing, a ceramic bearing, or an oil-retaining bearing.

Preferably, a connection between the pressing portion and the pushing portion is hinged to the brake lever by means of the first pivot; and the hydraulic cylinder is fixed to the interior of the control main body by means of a stationary shaft.

Preferably, the first pivot divides the brake lever into a connection portion and a holding portion extending along the connection portion; and an inner wall of the holding portion abuts against the pressing portion by means of an adjusting member for adjusting an angle or a spacing between the holding portion and the pressing portion.

Preferably, the adjusting member includes an adjusting body and a plurality of height-different adjusting bulges arranged on an end surface of the adjusting body, and the plurality of adjusting bulges can respectively abut against the pressing portion; and a clamping hole is formed in the holding portion, and an end, away from the adjusting bulges, of the adjusting body is in clearance fit with the clamping hole.

Preferably, the plurality of adjusting bulges are all strip-shaped bulges and are arranged around a circumferential direction of an end surface of the adjusting body.

Preferably, the adjusting body includes a clamping portion in clearance fit with the clamping hole and an abutting portion integrally connected to the clamping portion, and the adjusting bulges are arranged on an end, away from the clamping portion, of the abutting portion.

Preferably, the first pivot is sleeved with a reset torsional spring for driving the brake lever to reset.

Preferably, the hydraulic cylinder includes an oil storage chamber and a piston chamber which communicate by means of a communication hole, the piston rod can slide along the piston chamber, and the piston chamber is internally provided with a reset spring for resetting the piston rod; and
the oil storage chamber and the piston chamber are arranged side by side, wherein the piston chamber is located on a side close to the handlebar, and the oil storage chamber is located on a side away from the handlebar; the oil storage chamber and the piston chamber respectively communicate with the exterior by means of an oil filling port and an exhaust port; and the interior of each of the oil filling port and the exhaust port is sealed by means of a sealing plug.

A bicycle includes the above-mentioned bicycle hydraulic brake control device.

Compared with the prior art, the present invention has the beneficial effects that the bicycle hydraulic brake control device is applied to a bicycle and is reasonable and compact in structural design, the rolling member is arranged on the trigger member, and the piston rod is pushed by means of the rolling member to do a piston motion, so that a friction surface between the trigger member and the piston rod is prone to abrasion due to hard friction between the trigger member and the piston rod is avoided, and a friction force between the trigger member and the piston rod is reduced by means of the rolling member, so that a smoother hand feeling of braking is achieved, the braking effect is improved, and the rider's braking experience is also improved; the adjusting member is arranged to adjust the angle or the spacing between the holding portion and the pressing portion and then adjust a braking angle of the brake lever, so that braking with hands of different sizes is achieved, and the riding safety of users with small hands is ensured; the hydraulic cylinder and the brake lever are fixed by means of different shafts so as to be easy to disassemble, overhaul and maintain and high in reliability; and the oil filling port and the exhaust port are separately arranged, which avoids interaction between oil filling of the oil storage chamber and exhaust of the piston chamber and facilitates the oil filling and exhaust of the hydraulic cylinder.

### BRIEF DESCRIPTION OF THE DRAWINGS

In order to describe the technical solutions in the embodiments of the present invention or the prior art more clearly, the accompanying drawings required for describing the embodiments or the prior art will be briefly introduced below. Apparently, the accompanying drawings in the following description show only some embodiments of the present invention, and those of ordinary skill in the art may still derive other accompanying drawings from these accompanying drawings without creative work.

FIG. 1 is a schematic view of a bicycle hydraulic brake control device applied to a handlebar in an example of the present invention;

FIG. 2 is a structural view of a bicycle hydraulic brake control device in an example of the present invention;

FIG. 3 is a structural view of another viewing angle of a bicycle hydraulic brake control device in an example of the present invention;

FIG. 4 is an exploded view of a bicycle hydraulic brake control device in an example of the present invention;

FIG. 5 is a structural view of a bicycle hydraulic brake control device in an example of the present invention;

FIG. 6 is a structural view of a trigger member of a bicycle hydraulic brake control device in an example of the present invention;

FIG. 7 is a structural view of cooperation among a brake lever, a trigger member and a hydraulic cylinder of a bicycle hydraulic brake control device in an example of the present invention;

FIG. 8 is a sectional view of an M-M direction in FIG. 7;

FIG. 9 is a structural view of cooperation between a trigger member and a hydraulic cylinder of a bicycle hydraulic brake control device in an example of the present invention; and

FIG. 10 is a structural view of cooperation between a trigger member and a hydraulic cylinder of a bicycle hydraulic brake control device in an example of the present invention.

In the drawings: handlebar 10, control main body 20, containing groove 21, brake lever 30, holding portion 31, connection portion 32, first pivot 33, clamping hole 34, adjusting member 35, clamping portion 351, abutting portion 352, first adjusting bulge 353, second adjusting bulge 354, third adjusting bulge 355, fourth adjusting bulge 356, trigger member 40, reset torsional spring 41, pressing portion 401, pushing portion 402, U-shaped groove 403, third pivot 50, rolling member 51, hydraulic cylinder 60, cover plate 61, oil storage chamber 62, first sealing plug 621, oil filling port 622, piston chamber 63, second sealing plug 631, exhaust port 632, reset spring 64, piston rod 65, stationary shaft 66, communication hole 67, communication pipe 70, oil delivery pipe 71, and pipe clamp 80.

### DETAILED DESCRIPTION OF THE INVENTION

In order to make the above-mentioned objects, features and advantages of the present application more obvious and comprehensible, the present application will be further described in detail below in conjunction with the accompanying drawings and specific implementations.

In the description of the present application, it should be understood that directional or positional relationships indicated by terms such as “middle”, “top”, “bottom”, “inner” and “outer” are based on directional or positional relationships as shown in the accompanying drawings, and are only for the purposes of facilitating describing the present application and simplifying the description, rather than indicating or implying that the referred device or element has to have a specific direction or be constructed and operated in the specific direction, and therefore, they cannot be understood as limitations on the present application. Terms such as “first” and “second” are for descriptive purposes only, and cannot be understood as indicating or implying the relative importance or implicitly indicating the number of indicated technical features. Therefore, the features defined as “first” and “second” can explicitly or implicitly include at least one of the features. In the description of the present application, “a plurality of” means two or more unless it is specifically defined otherwise.

In addition, unless explicitly specified and defined otherwise, terms such as “mounted”, “connected”, “connection” and “fixed” should be understood in a broad sense, for example, “connection” may be fixed connection, detachable connection, or integrated connection, may be mechanical connection or electrical connection, may be direct connection or indirect connection through an intermediate medium, and may be internal communication of two elements. Those of ordinary skill in the art can understand the specific meanings of the above-mentioned terms in the present application according to specific situations.

In the present application, unless explicitly specified and defined otherwise, situations that a first feature is located “above” or “below” a second feature may include that the first and second features are in direct contact, or the first and second features are not in direct contact, but are in contact by means of another feature between them. Furthermore, situations that a first feature is located “on the upside of”, “above”, or “on” a second feature include that the first feature is located directly above and obliquely above the second feature, or simply means that a horizontal height of the first feature is greater than that of the second feature. Situations that a first feature is located “on the downside of”, “below”, or “under” a second feature include that the first feature is located directly below and obliquely below the second feature, or simply means that a horizontal height of the first feature is smaller than that of the second feature.

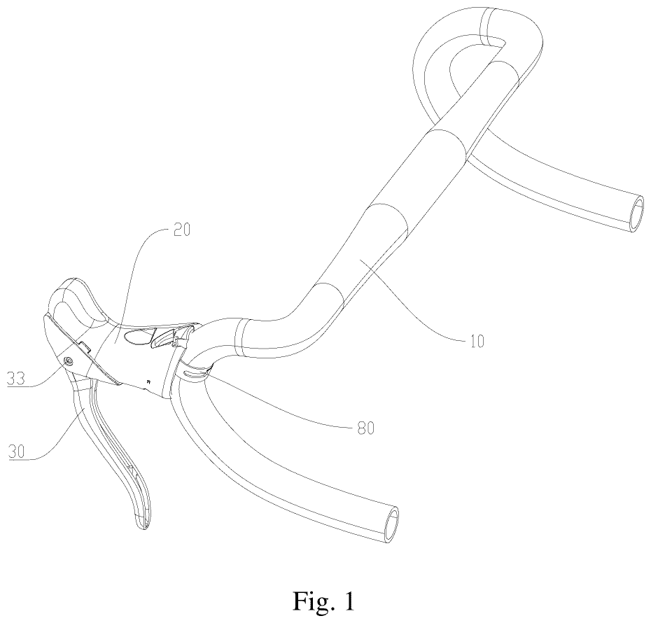

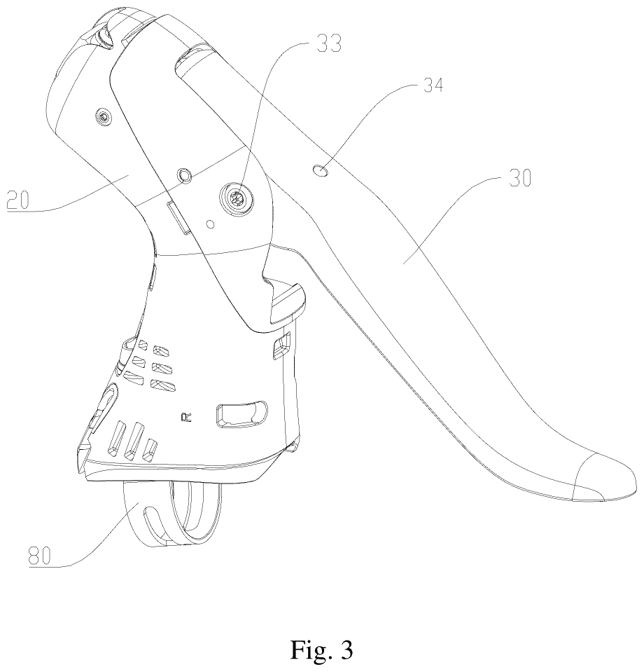

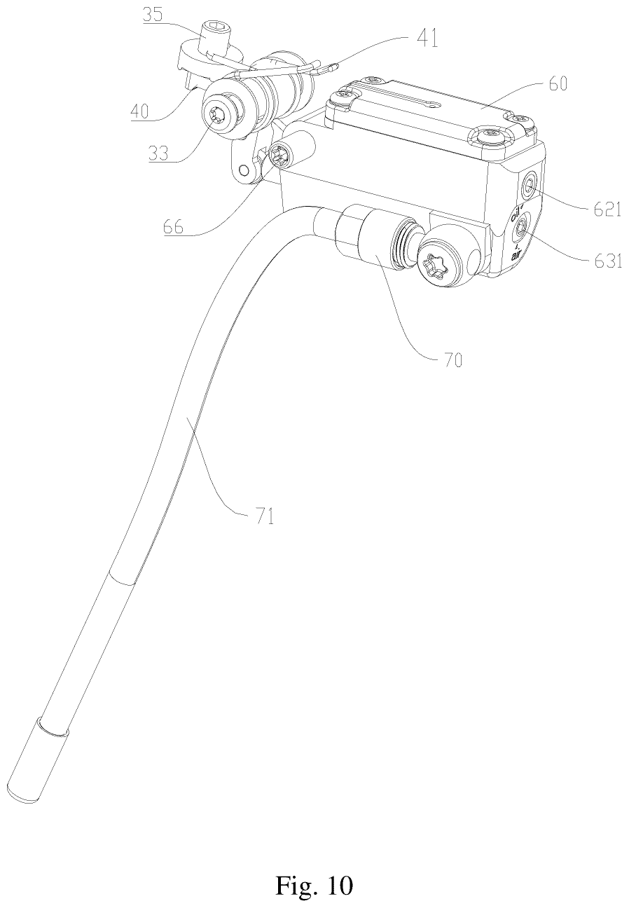

Embodiment: the present invention provides a bicycle hydraulic brake control device to mainly solve some problems such as friction surface abrasion caused by hard friction between a trigger member 40 and a piston rod 65, poor hand feeling of braking, low reliability and difficulty in disassembly, overhaul and maintenance of a hydraulic handbrake of a road bicycle on the current market. With reference to FIGS. 1 to 10, the hydraulic device is applied to a bicycle such as a mountain bicycle, a road bicycle and a children bicycle. Specifically, the hydraulic device includes:
a control main body 20, the control main body 20 being connected to a handlebar 10 of a bicycle;
a brake lever 30, the brake lever 30 being pivotally connected to an end, away from the handlebar 10, of the control main body 20 by means of a first pivot 33;
a hydraulic cylinder 60, the hydraulic cylinder 60 being connected to the interior of the control main body 20;
a piston rod 65, one end of the piston rod 65 being movably arranged in the hydraulic cylinder 60, and the other end thereof extending out of one end of the hydraulic cylinder 60; and
a trigger member 40, the trigger member 40 being hinged to the interior of the control main body 20 and being located on one side of the hydraulic cylinder 60, and the trigger member 40 being used for pushing the piston rod 65 to move along the interior of the hydraulic cylinder 60 and extruding hydraulic oil located in the hydraulic cylinder 60;
wherein the trigger member 40 includes a pressing portion 401 and a pushing portion 402 which are connected to each other at a preset angle, an end, away from the pushing portion 402, of the pressing portion 401 abuts against an inner wall of the brake lever 30, and an end, away from the pressing portion 401, of the pushing portion 402 is connected to an end, extending out of the hydraulic cylinder 60, of the piston rod 65 by means of a rolling member 51; and the rolling member 51 can roll along an end portion of the piston rod 65 when the brake lever 30 rotates along the first pivot 33 and extrudes the trigger member 40.

In the present embodiment, as shown in FIGS. 1 to 4, the control main body 20 is detachably connected to the handlebar 10 of the bicycle by means of a pipe clamp 80, and the brake lever 30 is pivotally connected to the end, away from the handlebar 10 of the control main body 20 by means of the first pivot 33; the hydraulic cylinder 60 is arranged on one end in the control main body 20, the piston rod 65 is matched in the hydraulic cylinder 60 to do the piston motion, and the trigger member 40 is hinged to the interior of the control main body 20; and during braking, the brake lever 30 is pressed, the trigger member 40 is driven to rotate, the trigger member 40 drives a piston in the hydraulic cylinder 60 to do the piston motion, and the piston rod pushes brake oil to complete a braking operation.

Specifically, one end of the trigger member 40 is connected with the rolling member 51 by means of a third pivot 50 and abuts against an end portion of the piston rod 65 by means of the rolling member 51, and when the brake lever 30 is pressed to drive the trigger member 40 to rotate, the trigger member 40 can push the piston rod 65 by means of the rolling member 51 to compress the hydraulic oil. In the prior art, hard contact and great friction are generated between one end of the trigger member 40 and the end portion of the piston rod 65, by which the trigger member 40 and the piston rod 65 are easily damaged, and at the same time, hard hand feeling of braking is caused. In the embodiment of the present application, the rolling member 51 is adopted to reduce a friction force between the trigger member 40 and the piston rod 65, the rolling member 51 rolls along an end surface of the piston rod 65, and then, the smooth degree of braking and the rider's braking experience are improved.

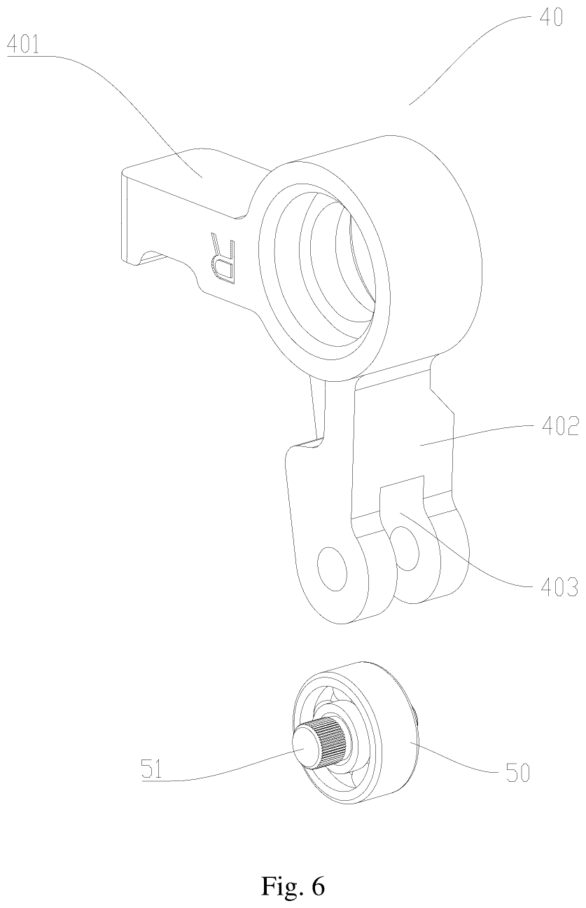

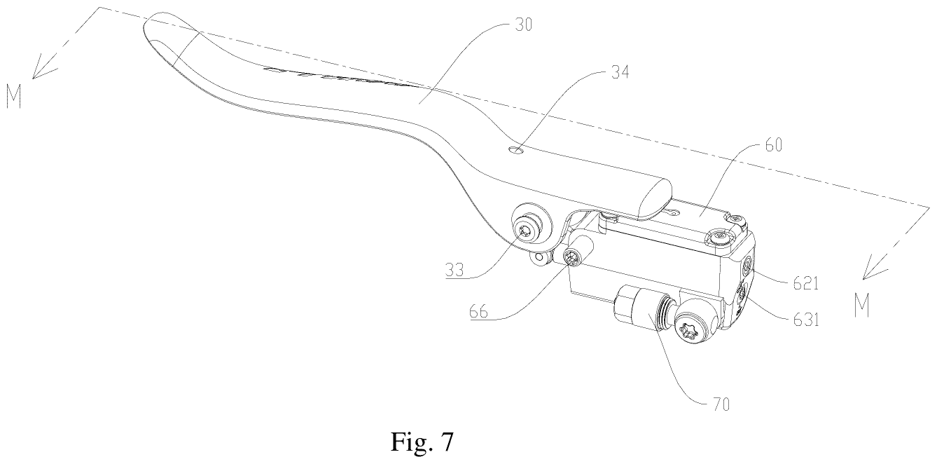

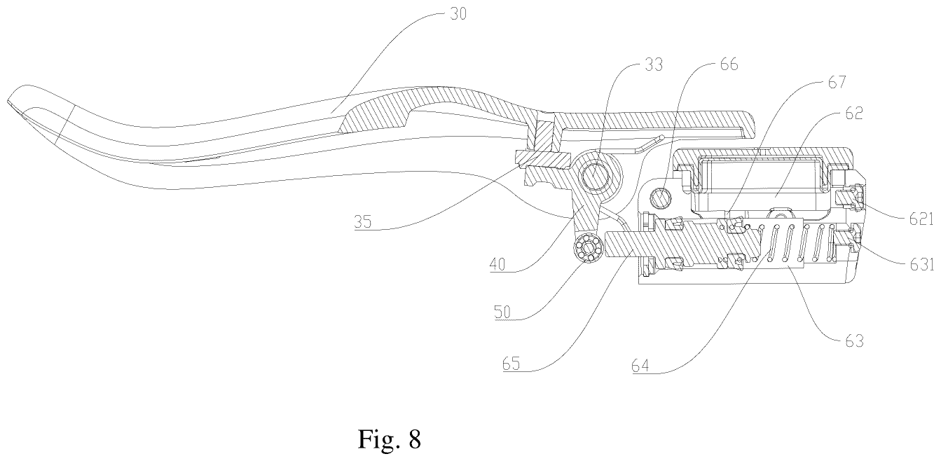

In the present embodiment, as shown in FIG. 6, FIG. 7 and FIG. 8, the trigger member 40 includes the pressing portion 401 and the pushing portion 402 which are connected to each other at the preset angle, the end, away from the pushing portion 402, of the pressing portion 401 abuts against the inner wall of the brake lever 30, and the end, away from the pressing portion 401, of the pushing portion 402 abuts against the end, extending out of the hydraulic cylinder 60, of the piston rod 65 by means of the rolling member 51; the preset angle is preferably 70° C. to 150° C., and in the present embodiment, the preset angle is 90° C. A connection between the pressing portion 401 and the pushing portion 402 is hinged to the brake lever 30 by means of the first pivot 33; and when the brake lever 30 is pressed, one end of the brake lever 30 presses downwards the pressing portion 401 and raises the pushing portion 402, thereby pushing the piston rod 65 to compress the hydraulic oil.

Specifically, the rolling member 51 is a rolling bearing pivotally connected to the end, away from the pressing portion 401, of the pushing portion 402. In a further embodiment, the end portion, away from the pressing portion 401, of the pushing portion 402 is provided with a U-shaped groove 403 for containing the rolling bearing, the rolling bearing is pivotally connected to the interior of the U-shaped groove 403 by means of a second pivot, and an edge of the rolling bearing extends out of the U-shaped groove 403 so as to abut against one end of the piston rod 65. Further, the rolling bearing is a ball bearing, a roller bearing, a needle roller bearing, a ceramic bearing, or an oil-retaining bearing. In the present embodiment, the rolling bearing is preferably the ball bearing.

In a specific embodiment, an axis of the first pivot 33 is lower than an axis position of the piston rod 65, so that there is an enough area on an end surface of the piston rod 65 to allow the rolling member 51 to roll.

Further, with reference to FIG. 7 to FIG. 10, the first pivot 33 divides the brake lever 30 into a connection portion 32 and a holding portion 31 extending along the connection portion 32; and an inner wall of the holding portion 31 abuts against the pressing portion 401 by means of an adjusting member 35 for adjusting an angle or a spacing between the holding portion 31 and the pressing portion 401. The adjusting member 35 is connected to the inner wall of the holding portion 31 and is close to one end of the connection portion 32, and the adjusting member 35 is arranged to adjust the spacing between the holding portion 31 and the pressing portion 401 and then adjust a braking angle of the brake lever 30, so that braking with hands of different sizes is achieved, and the riding safety of users with small hands is ensured.

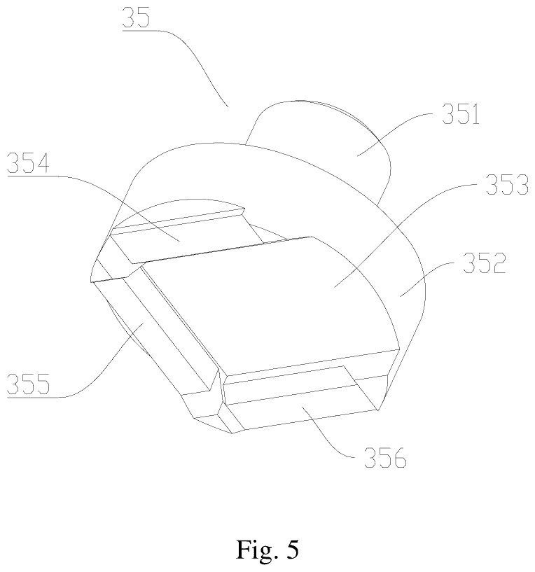

Specifically, with reference to FIG. 5, the adjusting member 35 includes an adjusting body and a plurality of height-different adjusting bulges arranged on an end surface of the adjusting body, and the plurality of adjusting bulges can respectively abut against the pressing portion 401; and a clamping hole 34 is formed in the holding portion, and an end, away from the adjusting bulges, of the adjusting body is in clearance fit with the clamping hole 34.

In the present embodiment, the clamping hole 34 is a through hole passing through the brake lever, one end of the adjusting member is in clearance fit with the clamping hole 34, and an end surface, located in the clamping hole 34, of the adjusting member is provided with an adjusting groove which may be a crossed groove, a linear groove, or a polygonal groove. Since the clamping hole is the through hole, by penetrating an adjusting tool along one end of the clamping hole 34 (i.e., one side of an outer wall of the brake lever) and rotating the adjusting member, corresponding adjusting bulges on the other end portion of the adjusting member abut against the trigger member according to specific demands of users.

Further, the plurality of adjusting bulges are all strip-shaped bulges and are arranged around a circumferential direction of an end surface of the adjusting body. As shown in FIG. 5, there are four adjusting bulges which are respectively a first adjusting bulge 353, a second adjusting bulge 354, a third adjusting bulge 355 and a fourth adjusting bulge 356, the four adjusting bulges are arranged end to end around a circumferential direction of an end surface of the adjusting body, and heights thereof are sequentially increased. In the present embodiment, the height of the first adjusting bulge 353 is 0, the adjusting body is rotated so that the pressing portion 401 is adapted to the different adjusting bulges, then, the angle or spacing between the pressing portion 401 and the inner wall of the brake lever is controlled, and then, the braking angle of the brake lever 30 is adjusted; that is, in the present embodiment, when the pressing portion 401 is located on the first adjusting bulge 353, the spacing or angle between the inner wall of the holding portion 31 and the pressing portion 401 is minimum, and when the pressing portion 401 is located on the fourth adjusting bulge 356, the spacing or angle between the inner wall of the holding portion 31 and the pressing portion 401 is maximum. Of course, in another embodiment, there may also be two, three, five, or more adjusting bulges, which is not limited therein.

Further, the plurality of adjusting bulges are provided with limiting grooves for containing the pressing portion 401. By arranging the limiting grooves, the pressing portion 401 is prevented from falling off from the adjusting bulges or moving. In a further embodiment, an inclined surface is arranged between the clamping grooves in the adjacent adjusting bulges to facilitate rotating the adjusting body and limiting the pressing portion 401 in the limiting grooves of the different adjusting bulges.

Further, the adjusting body includes a clamping portion 351 in clearance fit with the clamping hole 34 and an abutting portion 352 integrally connected to the clamping portion 351, and the adjusting bulges are arranged on an end surface, away from the clamping portion 351, of the abutting portion 352. In the present embodiment, each of the clamping portion 351 and the abutting portion 352 is a cylindrical structure; the clamping hole 34 is a circular hole; an external diameter of the abutting portion 352 is greater than an external diameter of the clamping portion 351; the adjusting groove is arranged in an end, away from the abutting portion 352, of the clamping portion 351 and is in clearance fit in the clamping hole 34; and the adjusting bulges are arranged on an end, away from the clamping portion 351, of the abutting portion 352. Under the action of a reset spring, an end, close to the clamping portion 351, of the abutting portion 352 always abuts against the inner wall of the brake lever; and an end, close to the clamping portion 351, of the abutting portion 352, i.e., an end provided with the adjusting bulges, always abuts against the pressing portion 401.

In another specific embodiment, the adjusting member 35 is a jackscrew, the clamping hole 34 is a screw hole passing through the holding portion 31, the screw hole is adapted to the jackscrew, one end of the jackscrew is in threaded connection to the interior of the screw hole and is provided with an adjusting hole, and the other end thereof abuts against the end, away from the pushing portion 402, of the pressing portion 401. By penetrating the adjusting tool along one end of the clamping hole 34, the jackscrew can be rotated, and a depth of screwing the jackscrew into the screw hole is adjusted, so that the spacing or angle between the inner wall of the holding portion 31 and the pressing portion 401 is adjusted.

When the depth of screwing the jackscrew into the screw hole is larger, the spacing between the inner wall of the holding portion 31 and the pressing portion 401 is smaller, at the moment, the braking angle is also smaller, which is applicable to the braking operation of a rider with small hands; and when the depth of screwing the jackscrew into the screw hole is smaller, the spacing or angle between the inner wall of the holding portion 31 and the pressing portion 401 is larger, at the moment, the braking angle is also larger, which is applicable to the braking operation of a rider with large hands. By arranging the adjusting member 35, the practicability of the brake is better.

In the present embodiment, the first pivot 33 is sleeved with a reset torsional spring 41 for driving the brake lever 30 to reset, that is, the pressing portion 401 can always abut against an end surface of the adjusting member, i.e., the adjusting bulges, under the action of the reset torsional spring 41; when the brake lever 30 is pressed, the reset torsional spring 41 is compressed; and when the brake lever 30 is released, the reset torsional spring 41 resets and drives the brake lever 30 to reset.

Further, with reference to FIG. 8 to FIG. 10, the hydraulic cylinder 60 is fixed to the interior of the control main body 20 by means of a stationary shaft 66. In the present embodiment, the hydraulic cylinder 60 and the brake lever 30 are connected to the control main body 20 by means of different shafts so as to be easy to disassemble, overhaul and maintain and high in reliability. The hydraulic cylinder 60 includes an oil storage chamber 62 and a piston chamber 63 which communicate by means of a communication hole 67, the piston rod 65 can slide along the piston chamber 63, and the piston chamber 63 is internally provided with a reset spring 64 for resetting the piston rod 65. In the present embodiment, the oil storage chamber 62 and the piston chamber 63 are arranged side by side and communicate by means of the communication hole 67, the interior of the oil storage chamber 62 can be used for adding and storing brake oil, and the communication hole 67 facilitates the flow of the brake oil into the piston chamber 63; and one end of the piston rod 65 is located in the oil storage chamber 62, and the other end thereof extends out of an end portion of the piston chamber 63 and abuts against the rolling member 51. The piston chamber 63 is also internally provided with the reset spring 64 along an axial direction of the piston rod 65, one end of the reset torsional spring 41 abuts against an end, located in the piston chamber 63, of the piston rod 65, and the other end thereof abuts against an inner wall of one end of the piston chamber 63. When the brake lever 30 is pressed to rotate with the first pivot 33 as an axis and drive the trigger member 40 to push the piston rod 65 to move along the axial direction, the piston rod 65 compresses the hydraulic oil, the reset torsional spring 41 compresses, and thus, a braking action is completed; and when the brake lever 30 is released, the reset torsional spring 41 elastically resets to push an end portion of the piston rod 65 to always abut against the rolling member 51.

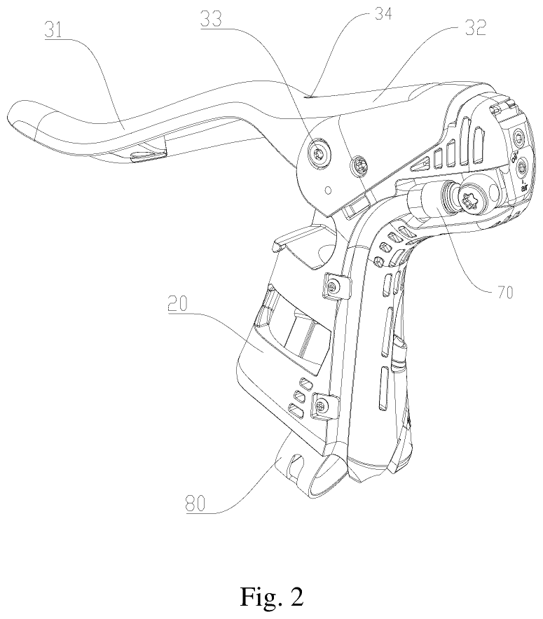

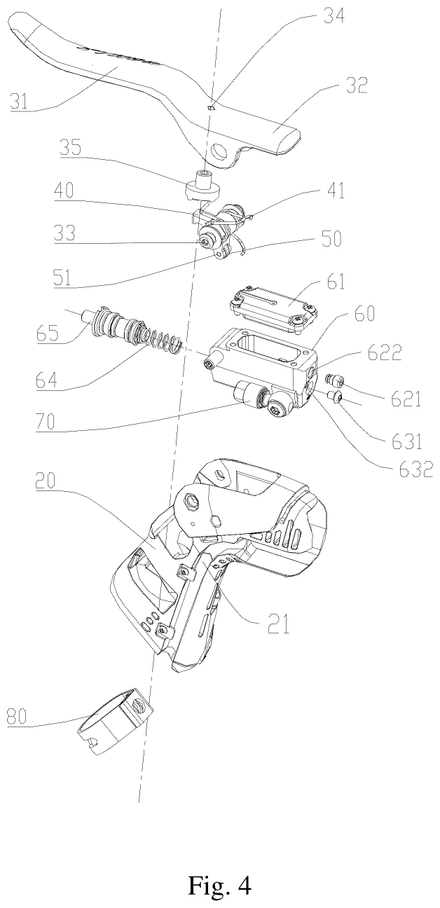

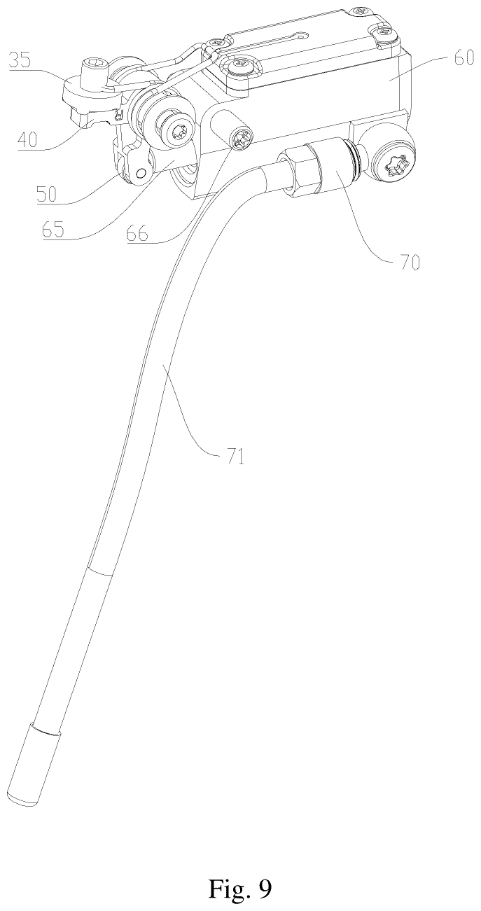

In a further embodiment, the oil storage chamber 62 and the piston chamber 63 respectively communicate with the exterior by means of an oil filling port 622 and an exhaust port 632; the oil filling port 622 and the exhaust port 632 are formed in an end, away from the trigger member 40, of the hydraulic cylinder 60, and the oil filling port 622 is used for adding the brake oil into the oil storage chamber 62; the exhaust port 632 is used for exhausting gases in the piston chamber 63 so as to better compress the brake oil to complete the braking operation; the oil filling port 622 and the exhaust port 632 are separately arranged, which avoids interaction between oil filling of the oil storage chamber 62 and exhaust of the piston chamber 63 and facilitates the daily oil filling and exhaust of the hydraulic cylinder 60; further, the oil filling port 622 is sealed by means of a first sealing plug 621; the exhaust port 632 is sealed by means of a second sealing plug 631; an upper end of the oil storage chamber 62 is provided with an opening sealed and covered by means of a cover plate 61 so as to facilitate cleaning the interior of the oil storage chamber 62; and as shown in FIG. 2, FIG. 4, FIG. 8 and FIG. 9, a side wall of the piston chamber 63 communicates with a communication pipe 70, the communication pipe 70 communicates with an oil delivery pipe 71 and is connected with a brake mechanism by means of the oil delivery pipe 71, and the brake oil drives the brake mechanism to complete the braking operation under the compression of the piston rod 65 according to the Pascal principle. A side wall of the control main body 20 is further provided with a containing groove 21 for containing the oil delivery pipe 71.

In a specific embodiment, when the spacing between the inner wall of the holding portion 31 and the pressing portion 401 is larger under the action of the adjusting member, the rolling member can push the piston rod 65 and drive the reset spring 64 to be slightly compressed, and exhaust can be performed by means of the exhaust port 632, so that an initial state of the piston rod 65 is adjusted.

Another specific embodiment of the present invention further provides a bicycle including the bicycle hydraulic brake control device in the above-mentioned embodiment.

The bicycle hydraulic brake control device is applied to a bicycle and is reasonable and compact in structural design, the rolling member 51 is arranged on the trigger member 40, and the piston rod 65 is pushed by means of the rolling member 51 to do a piston motion, so that a friction surface between the trigger member 40 and the piston rod 65 is prone to abrasion due to hard friction between the trigger member 40 and the piston rod 65 is avoided, and a friction force between the trigger member 40 and the piston rod 65 is reduced by means of the rolling member 51, so that a smoother hand feeling of braking is achieved, the braking effect is improved, and the rider's braking experience is also improved; the adjusting member 35 is arranged to adjust the spacing between the holding portion 31 and the pressing portion 401 and then adjust a braking angle of the brake lever 30, so that braking with hands of different sizes is achieved, and the riding safety of users with small hands is ensured; the hydraulic cylinder 60 and the brake lever 30 are fixed by means of different shafts so as to be easy to disassemble, overhaul and maintain and high in reliability; and the oil filling port 622 and the exhaust port 632 are separately arranged, which avoids interaction between oil filling of the oil storage chamber 62 and exhaust of the piston chamber 63 and facilitates the oil filling and exhaust of the hydraulic cylinder 60.

The above descriptions are only specific implementations of the present invention, but the protection scope of the present invention is not limited thereto. Any variations or substitutions that can be readily envisioned by those skilled in the art within the technical scope disclosed in the present invention should fall within the protection scope of the present invention. Therefore, the protection scope of the present invention should be subject to the protection scope defined in the claims.

1. A bicycle hydraulic brake control device, comprising:
a control main body, the control main body being connected to a handlebar of a bicycle;
a brake lever, the brake lever being pivotally connected to an end, away from the handlebar, of the control main body by means of a first pivot;
a hydraulic cylinder, the hydraulic cylinder being connected to the interior of the control main body;
a piston rod, one end of the piston rod being movably arranged in the hydraulic cylinder, and the other end thereof extending out of one end of the hydraulic cylinder; and
a trigger member, the trigger member being hinged to the interior of the control main body and being located on one side of the hydraulic cylinder, and the trigger member being used for pushing the piston rod to move along the interior of the hydraulic cylinder and extruding hydraulic oil located in the hydraulic cylinder;
wherein the trigger member comprises a pressing portion and a pushing portion which are connected to each other at a preset angle, an end, away from the pushing portion, of the pressing portion abuts against an inner wall of the brake lever, and an end, away from the pressing portion, of the pushing portion is connected to an end, extending out of the hydraulic cylinder, of the piston rod by means of a rolling member; and the rolling member can roll along an end portion of the piston rod when the brake lever rotates along the first pivot and extrudes the trigger member.

2. The bicycle hydraulic brake control device of claim 1, wherein the rolling member is a rolling bearing pivotally connected to the end, away from the pressing portion, of the pushing portion.

3. The bicycle hydraulic brake control device of claim 2, wherein the end portion, away from the pressing portion, of the pushing portion is provided with a U-shaped groove for containing the rolling bearing, and the rolling bearing is pivotally connected to the interior of the U-shaped groove by means of a second pivot.

4. The bicycle hydraulic brake control device of claim 2, wherein the rolling bearing is a ball bearing, a roller bearing, a needle roller bearing, a ceramic bearing, or an oil-retaining bearing.

5. The bicycle hydraulic brake control device of claim 1, wherein a connection between the pressing portion and the pushing portion is hinged to the brake lever by means of the first pivot; and the hydraulic cylinder is fixed to the interior of the control main body by means of a stationary shaft.

6. The bicycle hydraulic brake control device of claim 1, wherein the first pivot divides the brake lever into a connection portion and a holding portion extending along the connection portion; and an inner wall of the holding portion abuts against the pressing portion by means of an adjusting member for adjusting an angle or a spacing between the holding portion and the pressing portion.

7. The bicycle hydraulic brake control device of claim 6, wherein the adjusting member comprises an adjusting body and a plurality of height-different adjusting bulges arranged on an end surface of the adjusting body, and the plurality of adjusting bulges can respectively abut against the pressing portion; and a clamping hole is formed in the holding portion, and an end, away from the adjusting bulges, of the adjusting body is in clearance fit with the clamping hole.

8. The bicycle hydraulic brake control device of claim 7, wherein the plurality of adjusting bulges are all strip-shaped bulges and are arranged around a circumferential direction of an end surface of the adjusting body.

9. The bicycle hydraulic brake control device of claim 1, wherein the hydraulic cylinder comprises an oil storage chamber and a piston chamber which communicate by means of a communication hole, the piston rod can slide along the piston chamber, and the piston chamber is internally provided with a reset spring for resetting the piston rod; and
the oil storage chamber and the piston chamber are arranged side by side, wherein the piston chamber is located on a side close to the handlebar, and the oil storage chamber is located on a side away from the handlebar; the oil storage chamber and the piston chamber respectively communicate with the exterior by means of an oil filling port and an exhaust port; and the interior of each of the oil filling port and the exhaust port is sealed by means of a sealing plug.

10. A bicycle, comprising the bicycle hydraulic brake control device of claim 1.

11. A bicycle, comprising the bicycle hydraulic brake control device of claim 2.

12. A bicycle, comprising the bicycle hydraulic brake control device of claim 3.

13. A bicycle, comprising the bicycle hydraulic brake control device of claim 4.

14. A bicycle, comprising the bicycle hydraulic brake control device of claim 5.

15. A bicycle, comprising the bicycle hydraulic brake control device of claim 6.

16. A bicycle, comprising the bicycle hydraulic brake control device of claim 7.

17. A bicycle, comprising the bicycle hydraulic brake control device of claim 8.

18. A bicycle, comprising the bicycle hydraulic brake control device of claim 9.
